(19) United States
(12) Patent Application Publication
(10) Pub. No.: US 2002/0073010 A1
(43) Pub. Date: Jun. 13, 2002

(54) Secure electronic stocks and other titles and instruments

(76) Inventors: Charles Tresser, Mamaroneck, NY (US); Rosario Gennaro, Bronx, NY (US)

Correspondence Address: RICHARD L. CATANIA, ESQ, SCULLY, SCOTT, MURPHY AND PRESSER, 400 Garden City Plaza, Garden City, NY, 11530, US

(21) Appl. No.: 09/734,086

(22) Filed: Dec. 11, 2000

(51) Int. Cl. G06F 17/60

(52) U.S. Cl. 705/37

(57) ABSTRACT

A method and system for digitally managing financial instruments. In accordance with this method, an owner of a financial instrument creates a title for the instrument, and this title includes (i) a message describing the title and how to contact the owner, and (ii) a digital signature of the owner. The owner transfers ownership of the financial instrument to another person. To do this, the owner, appends to the title a public part of a signature scheme of that other person, and the owner signs the title using a public signature scheme of the owner. Preferably, when ownership is transferred, a number is appended to the title indicating the number of successive owners of the title. Also, preferably, the owner keeps the public part of the signature of the other person and makes that public part available to potential subsequent buyers.

### BACKGROUND OF THE INVENTION

1. Field of the Invention

This invention generally relates to electronic commerce, and more specifically, to methods and systems to establish and manage electronic titles.

2. Prior Art

One of the main virtues of any new form of trading is liquidity. In their book “Capital Market Revolution” (Pearson Education Limited, Harlow, 1999), the authors Patrick Young and Thomas Theys describe several transformations capital markets are undergoing because of an increasing role of electronic commerce. To facilitate further this transformation, electronic stocks and bonds, as well as other kinds of instruments could be themselves in digital form. As used herein, the term title refers to any security, or more generally, any certificate of property that one wishes to trade or sell. In particular this includes electronic money, the principles of which are described, for instance, in D. O'Mahony, M. Peirce, and H. Tewari: Electronic Payment Systems (Artech House, Boston, 1997). In such digital form, titles would be easy to keep (one can copy them several times to avoid loss), and easy to ship. The ease of this format results in possible vulnerability to frauds.

Several problems or issues need to be addressed in order to develop a mechanism to transfer titles electronically.

These problems and issues include:

1. No one should be able to create illegitimate titles.

2. We want the owner of a legitimate title to be able to sell it only once (for each time he/she buys it).

3. The owner of a title should be able to establish ownership.

4. A potential buyer of a title should have means to check that the sale will be legitimate.

5. The owner should be able to let know ownership only to the parties who need to know (such as the government or other regulatory bodies), and to those parties only, if so desired.

6. Whenever regulation allows for anonymous possession of a title, this should be possible.

7. Custodians should be usable if preferred or if necessary by law.

8. The titles should adapt to the increasing computational powers accessible to hackers.

### Summary Of The Invention

An object of the present invention is to provide a method and apparatus to create and do business with electronic titles.

Another object of this invention is to provide means to generate, trade, and administer digital stock certificates and other forms of digital financial instruments. These instruments can be either digital instruments to be traded at prices fixed by the market (e.g., digital stocks), or digital ownership certificates that can be used for non-anonymous payment. These and other objectives are attained with a method and system for digitally managing financial instruments. In accordance with this method, an owner of a financial instrument creates a title for the instrument, and this title includes (i) a message describing the title and how to contact the owner, and (ii) a digital signature of the owner. The owner transfers ownership of the financial instrument to another person. To do this, the owner, appends to the title a public part of a signature scheme of that other person, and the owner signs the title using a public signature scheme of the owner.

Preferably, when ownership is transferred, a number is appended to the title indicating the number of successive owners of the title. Also, preferably, the owner keeps the public part of the signature of the other person and makes that public part available to potential subsequent buyers.

### BRIEF DESCRIPTION OF THE DRAWINGS

The foregoing and other objects, aspects and advantages will be better understood from the following detailed description of a preferred embodiment of the invention, given with reference to the accompanying drawings, in which:

FIG. 1 illustrates an IBM 4758 PCI Cryptographic Coprocessor that may be used in the practice of this invention.

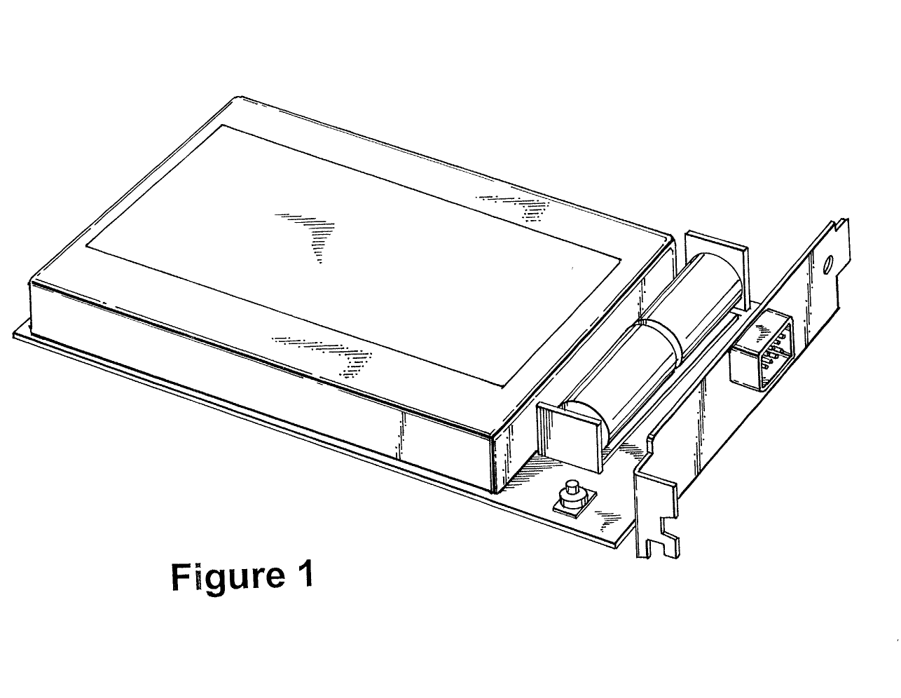

FIG. 2 is a block diagram that also illustrates a preferred operation of the invention.

### DETAILED DESCRIPTION OF THE PREFERRED EMBODIMENT

The preferred embodiment of the present invention uses a pair of technologies:

1.) the IBM 4758 PCI Cryptographic Coprocessor, and

2.) cryptography.

The IBM 4758 PCI Crytographic Coprocessor

The IBM 4758 PCI Cryptographic Coprocessor is a programmable, field upgradeable piece of secure hardware that has a general purpose computational power about equivalent to a personal computer from the early 1990's. It performs high-speed cryptographic operations, and provides secure key storage. It is both cryptographically secure and able to detect and protect itself against physical attacks (probe, voltage, temperature, radiation). It is in fact one of the only two devices that are Federal Information Processing Standard (FIPS) 140-1 overall 4 certified (hardware and microcode: certificate #35), the other one coming integrated in IBM 390 mainframes (the IBM CMOS Cryptographic Coprocessor: certificate #40), while the price of an IBM 4758 is about a couple of thousand dollars. The IBM 4758 is indeed a popular PCI bus interface for servers, and can serve as device driver for NT, AIX, OS/2, Linux, and OS/390.

Typical use of cryptographic coprocessors such as the IBM 4758 or some smart cards include High Speed, Bulk Cryptography (for instance, for digital movies, in-flight entertainment systems, secure databases, confidential video-conferences, telemedicine, telecommuting, etc.) and Security in Non Trusted Environments (for instance, for smart card personalization, electronic currency dispensers, electronic benefits transfer, server-based smart card substitutes, home banking, certification authorities, secure database key control, e-postage meters, electronic payments, secret algorithms, secure time stamps, contest winner selection, software usage metering, electronic securities trading, hotel room gaming, etc.).

As will be understood by those of ordinary skill in the art, other devices having features similar to the abovediscussed features of the IBM 4758 may also be used in the practice of this invention.

Cryptography

The use of Private key/public key pairs (or SK/PK pairs; we also say public schemes) as means to encrypt or digitally sign a file or document, of secret encoding keys, and of secure hash functions (such as SHA-1,as fully specified in the Federal Information Processing Standard Publication 180-1) are now well known. A description of these techniques with directions on how to use several of their implementations can be found in “Handbook of applied Cryptography”, by Alfred J. Menezes, Paul C. van Oorschot and Scott A. Vanstone, CRC Press, 1997.

To fix the ideas, we recall that a digital signature scheme is used in the form of a pair of functions, Sign and Sign⁻¹, which are the inverse of each other, i.e., for a plain text X to be signed, Sign⁻(Sign(X))=X. The function Sign is kept secret, being known only to some legitimate owner of the signature and his/her agents. The function Sign⁻¹ is known publicly, and accessible, for instance, through the World Wide Web (WWW), through some agency specializing in providing PKI, or given away by the owner of the pair to whoever needs to check the identity of the sender and/or that a message is exactly as the owner intended it to be.

We also recall that a public encryption scheme is used in the form of a pair of functions, Encr and Encr⁻¹, which are the inverse of each other, i.e., for a plain text X to be signed, Sign⁻¹(Sign(X))=X. The function Encr⁻¹ is kept secret, being known only to some legitimate owner of the signature and his/her agents. The function Encr is known publicly, and is accessible, for instance, through the WWW, or through some agency specializing in providing PKI, or given away by the owner of the pair to whoever wants to send the owner a secret message, or keep secret some part of the message.

For definiteness, each time we use a public scheme, one can choose the Rivest-Shamir-Adleman(RSA) protocol as a method to generate and use a SK/PK pair in order to allow for public encryption or digital signature. Several other methods could also be used (see, e.g., the “Handbook of applied Cryptography”). In the case when the functions Sign and Sign⁻¹ (or Encr⁻¹ and Encr) are produced according to the RSA protocol, it is now preferred to use at least 1024 digits for X and Sign(X) (the formerly often used 512 digits are no more considered as secure). As a message may contain much more information than the length of the keys, several methods can be used, possibly concurrently, as is well known in the art.

For instance, one can split the message into several pieces, some or all of which will be signed, or one can compress the information, for instance, using a secure hash function, or one can select a subset of the information, etc. Clearly, the protocol which is chosen has to be known publicly if one desires to use public key cryptography. Also, it should be noted that even if one wishes to uses the benefits of public key cryptography, it may be useful to also hide secret information in the messages, so that one could recognize that someone has succeeded in breaking the keys being used. As usual in the art, it is advisable to change the keys being used every so often, depending on the application, and to keep a list of former keys.

The present invention uses the above-described technologies to provide a method and apparatus to create and to do business with electronic titles, such as digital shocks, while successfully addressing the abovementioned problems. As for most forms of electronic money or more general value, the first basic idea is to create a title as a pair formed by:

i) a message describing the title and how to contact the originator for business related to this title, and

ii) the digital signature of the title by the party which emits it.

The specificity of the present approach will next be described. When this title begins to circulate through successive owners, record is kept of the circulation on the title as follow: seller S appends the public part, Sign⁻¹_{B}, of the signature scheme of the buyer B and, using his/her own public signature scheme, Signₛ, signs a message such as

Title sold to the owner of Sign⁻¹_{B}, to be owner N

where N is the number of successive owners which will have possessed this title since emission (or re-emission as described below). This number N, as well as Sign⁻¹_{B}, is communicated to the party which emits the titles, which keep it available to potential next buyers (possibly for a fee). When a potential buyer checks on the number, he/she asks the emitting party to freeze the possibility of selling that title to anyone else, for the very brief time needed to perform the purchase.

Exchanges of money can all be done anonymously if permitted by regulations, using some form of digital cash, as described for instance in “Electronic Payment Systems” (Artech House, Boston, 1997) by Donald O'Mahony, Michael Pierce, and Hitesh Tewari.

The signature schemes all along the path prevent creation of illegitimate titles (except possibly by the emitting party: see below) and sale by illegitimate owners. The use of the number N prevents a double sale, and, together with the list of successive Sign⁻¹_{B}'s by the emitter, insures the buyer that the sale will be legitimate. Custodians can be used with no problems, with blinded titles if desired and permitted by regulations. Privacy, even from the custodian, can be achieved by the simple use of encryption, and reporting to legal authorities in proper form can be done with no difficulty if required, as can be readily implemented by anyone versed in the art of cryptography.

To avoid carrying message that are too long, a title can be replaced by a new title emitted from the same source or another source. On such renewal of titles, stronger cryptographic methods can be introduced as needed, according to the progress of processing power available to potential hackers.

To protect against possible improper or unauthorized use by emitters or some employee, it may be required that all title emissions be done using secure hardware such as the IBM 4758 PCI Cryptographic Coprocessor. In fact, it may be a good principle that all operations along the chain be performed using such devices, but this may decrease liquidity, and it may be more preferred to require it only for the emitter, and optionally for all parties for very valuable titles. Some smart cards may also be considered safe enough to perform some or all of the operations.

It should be noted that in this system, the emitter acts as a trusted third party. The security of the whole system relies on the assumption that the emitter will always be available and it will never be maliciously compromised. Whenever we are faced with the task of maintaining an on-line, secure, trusted party, it makes sense to use the tools of threshold cryptography to help achieve the desired properties. In the threshold cryptography model, the role of the emitter is fulfilled by a set of servers, which may be geographically distributed, and possibly administered by different entities. These servers perform the emitter operations using a secure, fault-tolerant protocol. The idea is to reduce the amount of trust required from each of these servers, since as long as not too many servers misbehave, the emitter operation will not be affected.

The basic way to distribute the emitter, is to use threshold cryptography for the signature operation. Namely, the signing key of the emitter will be shared between the servers, and a document will be considered signed only if a qualified subset of servers decides to sign it. Usually this is achieved via a threshold method: there are N servers and it is necessary that K of them agree to sign the document. Threshold versions for the most commonly used signature schemes are described in two papers by Gennaro et al. for both RSA (R. Gennaro, S. Jarecki, H. Krawczyk, T. Rabin “Robust and Efficient Sharing of RSA Functions”, J. Of Cryptology, vol. 13, no. 2, pp. 273-300, Spring 2000) and DSS (R. Gennaro, S. Jarecki, H. Krawczyk, T. Rabin, “Robust Threshold DSS Signatures,” Proceedings of EUROCRYPT′96, Springer Verlag, LNCS 1070, pp. 354-371) signature schemes. These ideas are briefly summarized below.

The secret key is shared among the N servers using Shamir's secret sharing protocol. This will guarantee than K servers are required to reconstruct the key, while K-1 have no information about it. When a document is presented to the servers, they decide if they want to sign it or not. If the document warrants a signature (decided by at least K of the servers), a signature must be produced. A possible way to do this is to reconstruct the signing key and use the signing algorithm. But this is not acceptable since the key will reside (even if temporarily) on a single location which may be compromised. Thus, what is needed is a distributed protocol in which each server using its own partial key and the message, produces a partial signature. From at least K partial signatures, the real signature is then computed.

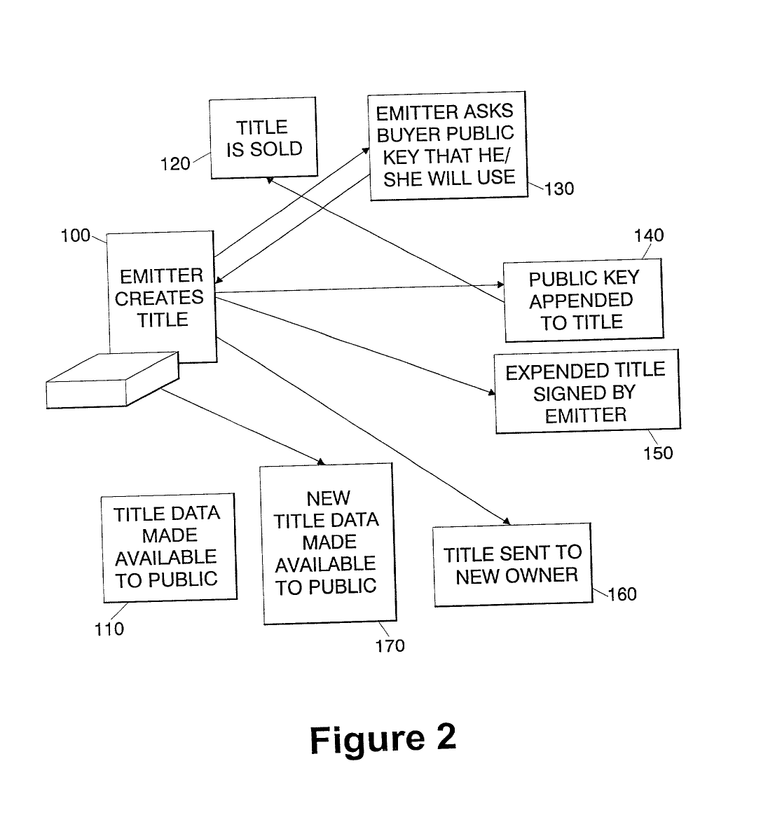

With reference now to FIG. 2, at 100, using preferably secure hardware, the emitter creates titles, which are pairs formed by a message and its signature. The message contains methods to contact the emitter for further trades and information, and the public key of the emitter. As soon as a title is created, its serial number and description are made available at 110 by public and/or access-paying means which may include the Internet.

The title is sold at 120. To complete the sale, the emitter asks the buyer for the public key, which he/she will use at 130. The key is appended to the title at 140. The newly expanded title is then signed by the emitter at 150. The signed title, which now contains information about the new owner, is then sent (in fact fully described would be enough) to the new owner at 160. The emitter next posts, near the description of the title, that there is a new owner, and describes the public key of the new owner at 170.

To prevent its owner, and in particular ill intentioned employees, from getting information that should remain confidential, the only instructions the IBM 4758 will accept (referred to as acceptable instructions) are:

1) instructions to print lists of titles numbers, or—if privacy is considered—checks of validity of some titles, and

2) descriptions of the public parts of the schemes it uses.

The 4758 may be equipped with an access reserved to regulatory bodies which may interrogate further the machine.

While it is apparent that the invention herein disclosed is well calculated to fulfill the objects stated above, it will be appreciated that numerous modifications and embodiments may be devised by those skilled in the art, and it is intended that the appended claims cover all such modifications and embodiments as fall within the true spirit and scope of the present invention.

1. A method of digitally managing financial instruments, comprising the steps:
an owner, creating a title for a financial instrument, the title including (i) a message describing the title and how to contact the owner, and (ii) a digital signature of the owner;
the owner transferring ownership of the financial instrument to another person, including the steps of
i) the owner appending to the title a public part of a signature scheme of said other person, and
ii) the owner signing the title using a public signature scheme of the owner.

2. A method according to claim 1, wherein the transferring step includes the step of appending to the title a number indicating the number of successive owners of the title.

3. A method according to claim 1, further comprising the step of the owner keeping the public part of the signature of the other person and making said public part available to potential subsequent buyers.

4. A method according to claim 1, further comprising the step of sending the title, with the signature of the owner made using the public signature scheme of the owner, to said other person.

5. A method according to claim 1, wherein the creating step includes the step of using a secure cryptographic generator to create the title.

6. A method according to claim 5, wherein the secure cryptographic generator is an IBM 4758.

7. A system for digitally managing financial instruments, comprising:
means for an owner to create a title for a financial instrument, the title including (i) a message describing the title and how to contact the owner, and (ii) a digital signature of the owner; and
means for the owner to transfer ownership of the financial instrument to another person, including
i) means for the owner to append to the title a public part of a signature scheme of said other person, and
ii) means for the owner to sign the title using a public signature scheme of the owner.

8. A system according to claim 7, wherein the means to transfer ownership includes means for appending to the title a number indicating the number of successive owners of the title.

9. A system according to claim 7, further comprising means for the owner to keep the public part of the signature of the other person, and to make said public part available to potential subsequent buyers.

10. A system according to claim 7, further comprising means for sending the title, with the signature of the owner made using the public signature scheme of the owner, to said other person.

11. A system according to claim 7, wherein the means for creating includes a secure cryptographic generator.

12. A system according to claim 11, wherein the secure cryptographic generator is an IBM 4758.

13. A program storage device readable by machine, tangibly embodying a program of instructions executable by the machine to perform method steps for digitally managing financial instruments, said method steps comprising:
an owner, creating a title for a financial instrument, the title including (i) a message describing the title and how to contact the owner, and (ii) a digital signature of the owner;
the owner transferring ownership of the financial instrument to another person, including the steps of
iii) the owner appending to the title a public part of a signature scheme of said other person, and
iv) the owner signing the title using a public signature scheme of the owner.

14. A program storage device according to claim 13, wherein the transferring step includes the step of appending to the title a number indicating the number of successive owners of the title.

15. A program storage device according to claim 13, wherein said method steps further comprise the steps of the owner keeping the public part of the signature of the other person, and making said public part available to potential subsequent buyers.

16. A program storage device according to claim 13, wherein said method steps further comprise the step of sending the title, with the signature of the owner made using the public signature scheme of the owner, to said other person.

17. A program storage device according to claim 13, wherein the creating step includes the step of using a secure cryptographic generator to create the title.

18. A program storage device according to claim 17, wherein the secure cryptographic generator is an IBM 4758.
